(19) United States
(12) Patent Application Publication
(10) Pub. No.: US 2024/0372240 A1
(43) Pub. Date: Nov. 7, 2024

(54) DISTRIBUTED CONSTANT CIRCUIT

(71) Applicant: ROHM CO., LTD., Kyoto (JP)

(72) Inventors: Fumiya NAGASAWA, Kyoto (JP); Hiroshi SEKIGUCHI, Kyoto (JP)

(73) Assignee: ROHM CO., LTD., Kyoto (JP)

(21) Appl. No.: 18/775,941

(22) Filed: Jul. 17, 2024

Related U.S. Application Data
(63) Continuation of application No. PCT/JP2023/006337, filed on Feb. 22, 2023.

(30) Foreign Application Priority Data
Feb. 22, 2022 (JP) 2022-025817

(51) Int. Cl. H01P 1/203

(52) U.S. Cl. CPC H01P 1/203

(57) ABSTRACT

One aspect of the embodiments herein provides a distributed constant circuit which can be reduced in size or reduced in height. The distributed constant circuit includes: a dielectric including a first main surface and a second main surface opposed to the first main surface; a transmission line arranged on the first main surface; and a ground electrode arranged on the second main surface. The transmission line includes a first line, a second line, and a third line that are formed to have different widths. The transmission line includes a periodic structure in which the first line, the second line, the third line, the second line, and the first line are arranged in series in this order.

### CROSS-REFERENCE TO RELATED APPLICATIONS

The present application is a continuation of International Application No. PCT/JP2023/006337, filed on Feb. 22, 2023, and based upon and claims the benefit of priority from Japanese Patent Application No. 2022-025817, filed on Feb. 22, 2022, the entire contents of which are incorporated herein by reference.

### TECHNICAL FIELD

The embodiments herein relate to a distributed constant circuit.

### BACKGROUND

When a band-pass filter circuit is configured in an electrical circuit, there is a generally known configuration which combines an inductor and a capacitor and uses a passive filter using resonant circuit characteristics. In addition, it is known that a band-pass filter circuit can be implemented by a lumped constant circuit simulating an equivalent circuit of a Su-Schrieffer-Heeger model (hereinafter referred to as an SSH model) having topological characteristics.

### BRIEF DESCRIPTION OF THE DRAWINGS

FIG. 1A illustrates a distributed constant circuit according to a first embodiment and is a configuration diagram for one period.

FIG. 1B illustrates a distributed constant circuit according to the first embodiment and is a configuration diagram for two periods.

FIG. 2A is a cross-sectional view which is taken along line A1-A1 in FIGS. 1A and 1B.

FIG. 2B is a cross-sectional view which is taken along line A2-A2 in FIGS. 1A and 1B.

FIG. 2C is a cross-sectional view which is taken along line A3-A3 in FIGS. 1A and 1B.

FIG. 3A illustrates the distributed constant circuit according to the first embodiment and is an equivalent circuit diagram of one period.

FIG. 3B illustrates the distributed constant circuit according to the first embodiment and is an equivalent circuit diagram of two periods.

FIG. 4A is an explanatory diagram of an SSH model without topological characteristics.

FIG. 4B is an explanatory diagram of an SSH model with topological characteristics.

FIG. 5 is an explanatory diagram illustrating polyacetylene with single bonds and double bonds of carbon atoms.

FIG. 6 is an equivalent circuit diagram simulating the single bonds and double bonds of carbon atoms in FIG. 5.

FIG. 7A illustrates a distributed constant circuit according to a second embodiment and is a configuration diagram for one period.

FIG. 7B illustrates a distributed constant circuit according to the second embodiment and is a configuration diagram for two periods.

FIG. 8A is a cross-sectional view which is taken along line A4-A4 in FIGS. 7A and 7B.

FIG. 8B is a cross-sectional view which is taken along line A5-A5 in FIGS. 7A and 7B.

FIG. 8C is a cross-sectional view which is taken along line A6-A6 in FIGS. 7A and 7B.

FIG. 9A illustrates the distributed constant circuit according to the second embodiment and is an equivalent circuit diagram of one period.

FIG. 9B illustrates the distributed constant circuit according to the second embodiment and is an equivalent circuit diagram of two periods.

FIG. 10 illustrates a distributed constant circuit according to a third embodiment and is a configuration diagram for three periods in X and Y directions.

FIG. 11A is a cross-sectional view which is taken along line A7-A7 in FIG. 10.

FIG. 11B is a cross-sectional view which is taken along line A8-A8 in FIG. 10.

FIG. 11C is a cross-sectional view which is taken along line A9-A9 in FIG. 10.

FIG. 12 illustrates the distributed constant circuit according to the third embodiment and is an equivalent circuit diagram of three periods in the X and Y directions.

### DETAILED DESCRIPTION

The embodiments herein will be described with reference to the drawings. In the description of the drawings below, the same or similar parts are denoted with the same or similar reference numerals. However, it should be noted that the drawings are schematically illustrated, and the relationship between the thickness and the plane dimension of each component and the like are different from those in reality. Therefore, the specific thickness and dimension should be determined in consideration of the following description. Further, it is needless to say that the drawings include portions where the relationships and ratios of dimensions are different between drawings.

Further, the following embodiments exemplify an apparatus and a method for embodying the technical concept, and the embodiments do not specify the material, shape, structure, arrangement, and the like of each component. Various modifications may be made to the embodiments herein within the scope of claims.

### First Embodiment

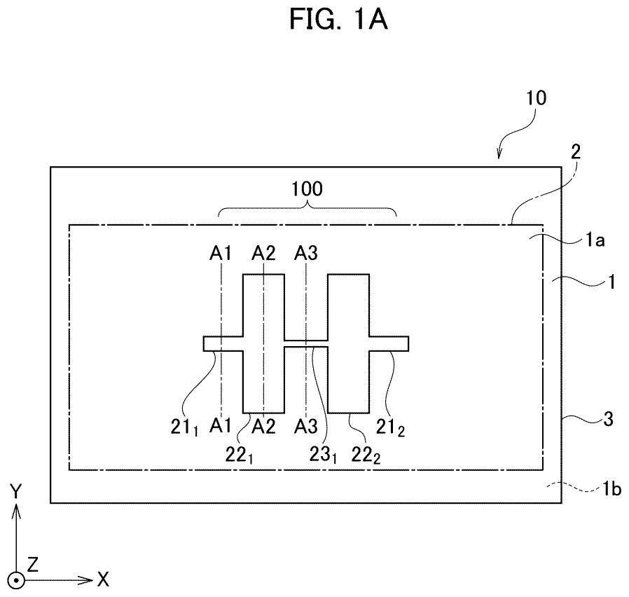

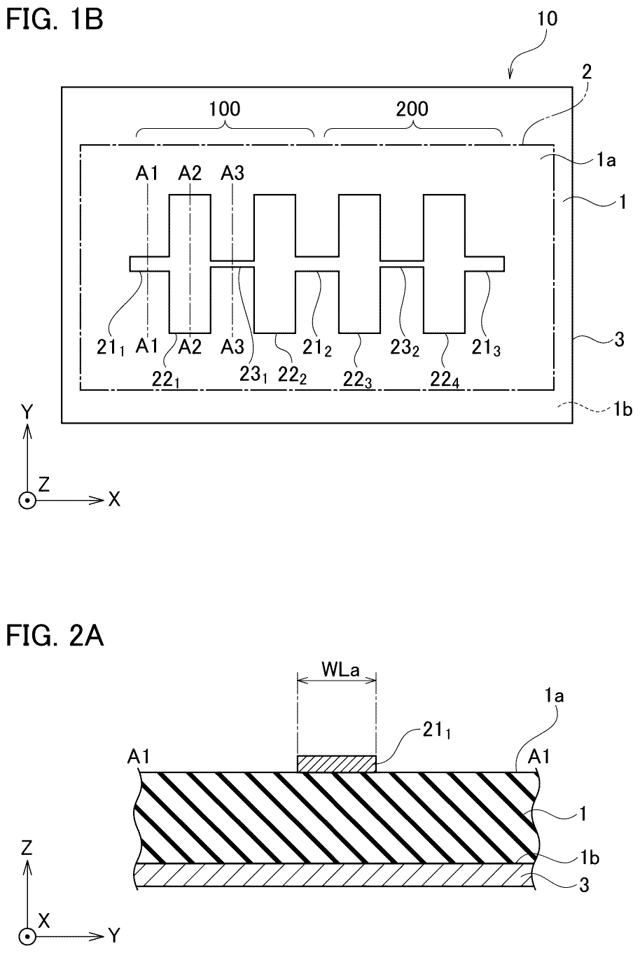

FIG. 1A illustrates a distributed constant circuit 10 according to a first embodiment and is a configuration diagram for one period. FIG. 1B illustrates a distributed constant circuit 10 according to the first embodiment and is a configuration diagram for two periods. FIG. 2A is a cross-sectional view which is taken along line A1-A1 in FIGS. 1A and 1B. FIG. 2B is a sectional structural view which is taken along line A2-A2 in FIGS. 1A and 1B. FIG. 2C is a cross-sectional view which is taken along line A3-A3 in FIGS. 1A and 1B. Device planes in plan views illustrated in FIGS. 1A and 1B are defined as X-Y planes, and a direction perpendicular to the X-Y planes is defined as a Z axis for description. FIGS. 2A, 2B, and 2C are Y-Z planes viewed from an X direction. That is, a first direction of a dielectric 1 is referred to as the X direction, a second direction crossing the X direction is referred to as a Y direction, and a third direction is referred to as a Z direction. In the following description, it is assumed that the first direction is the X direction, the second direction is the Y direction, and the third direction is the Z direction.

As illustrated in FIGS. 1A and 1B, the distributed constant circuit 10 according to the first embodiment includes the dielectric 1, a transmission line 2, and a ground electrode 3.

As illustrated in FIGS. 1A, 1B, and 2A to 2C, the dielectric 1 includes a first main surface 1a and a second main surface 1b opposed to the first main surface 1a. As illustrated in FIGS. 1A and 1B, the dielectric 1 is formed of a rectangular insulating material in plan view of a device plane on the first main surface 1a, for example.

As illustrated in FIGS. 1A and 1B, the transmission line 2 is arranged on the first main surface 1a. As illustrated in FIG. 1A, the transmission line 2 has first lines 21₁, 21₂, second lines 22₁, 22₂, and a third line 23₁ formed to have different widths. Further, as illustrated in FIG. 1B, the transmission line 2 has first lines 21₁, 21₂, 21₃, second lines 22₁, 22₂, 22₃, 22₄, and third lines 23₁, 23₂ formed to have different widths. The first lines 21₁, 21₂, 21₃, the second lines 22₁, 22₂, 22₃, 22₄, and the third lines 23₁, 23₂ are formed of metals having good conductivity. Specifically, copper (Cu), aluminum (A1), and gold (Au) can be used.

The transmission line 2 includes a microstrip line. That is, the transmission line 2 can be formed by a transmission path of a microstrip line, for example. The transmission line 2 is not limited to a microstrip line. In the following description, the transmission line 2 will be described using a microstrip line as an example.

As illustrated in FIG. 1A, the transmission line 2 include, as a configuration for one period, a periodic structure 100 in which the first line 21₁, the second line 22₁, the third line 23₁, the second line 22₂, and the first line 21₂ are arranged in series in this order. Further, as illustrated in FIG. 1A, in the transmission line 2, the first line 21₁, the second line 22₁, the third line 23₁, the second line 22₂, and the first line 21₂ are electrically connected. In the following description, a structure in which the first line 21₁, the second line 22₁, the third line 23₁, the second line 22₂, and the first line 21₂ are arranged in series in this order will be referred to as the periodic structure 100. Note that the number of the periodic structure 100 is not limited to one.

As illustrated in FIG. 1B, the transmission line 2 includes, as a configuration for two periods, the periodic structure 100 in which the first line 21₁, the second line 22₁, the third line 23₁, the second line 22₂, and the first line 21₂ are arranged in this order, and a periodic structure 200 in which the first line 21₂, the second line 22₃, the third line 23₂, the second line 22₄, and the first line 21₃ are arranged in series in this order. Further, as illustrated in FIG. 1B, in the transmission line 2, the first line 21₂, the second line 22₃, the third line 23₂, the second line 22₄, and the first line 21₃ are electrically connected. In the following description, a structure in which the first line 21₂, the second line 22₃, the third line 23₂, the second line 22₄, and the first line 21₃ are arranged in series in this order will be referred to as the periodic structure 200. The number of the periodic structures 100 and 200 may be more than one and they may be electrically connected.

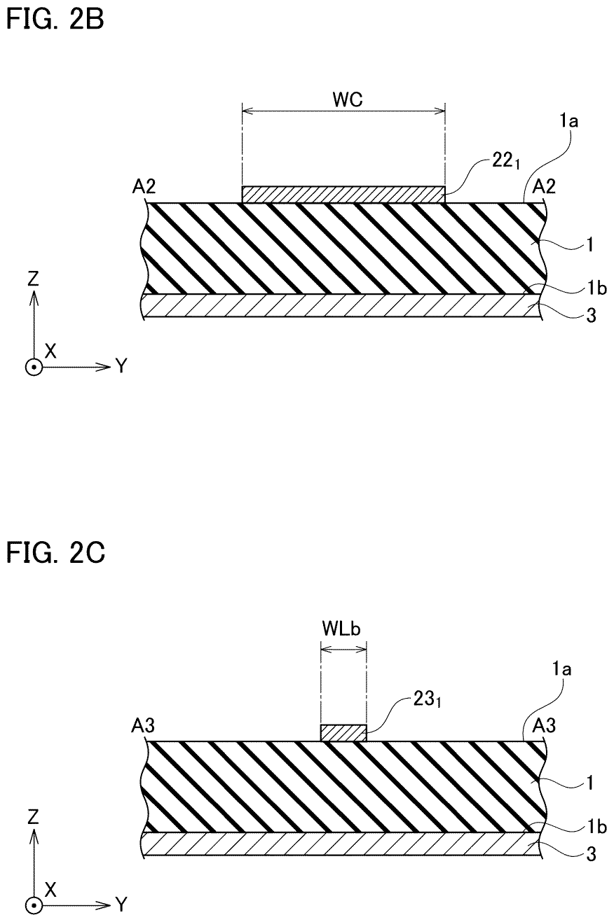

A circuit configuration of the transmission line 2 will be described below with reference to FIGS. 3A and 3B.

As illustrated in FIGS. 1A, 1B, and 2A, the first line 21₁ is formed to have a small line width WLa in the Y direction as a microstrip line of the transmission line 2, and functions as a first series inductor La. As illustrated in FIG. 2A, the first line 21₁ is disposed on the first main surface 1a opposed to the second main surface 1b on which the ground electrode 3 is disposed, with the dielectric 1 being interposed between the first main surface 1a and the second main surface 1b.

As illustrated in FIGS. 1A, 1B, and 2B, the second line 22₁ is formed to have a large line width WC in the Y direction as a microstrip line of the transmission line 2, and functions as a parallel capacitor C. As illustrated in FIG. 2B, the second line 22₁ is arranged on the first main surface 1a. As illustrated in FIGS. 1A and 1B, the line width WC of the second line 22₁ is larger than the line width WLa of the first line 21₁ and a line width WLb of the third line 23₁.

As illustrated in FIGS. 1A, 1B, and 2C, the third line 23₁ is formed to have a small line width WLb in the Y direction as a microstrip line of the transmission line 2, and functions as a second series inductor Lb. As illustrated in FIG. 2C, the third line 23₁ is arranged on the first main surface 1a. As illustrated in FIGS. 1A and 1B, the line width WLb of the third line 23₁ is smaller than the line width WLa of the first line 21₁.

As illustrated in FIGS. 1A, 1B, and 2A to 2C, the ground electrode 3 is arranged on the second main surface 1b. The ground electrode 3 may be connected to a potential that serves as a reference for a circuit operation, for example.

In the present specification or the like, the term “electrically connected” includes a case where connection is made via “a material having some electrical action”. Here, “a material having some electrical action” is not particularly limited as long as the material enables transmission and reception of an electrical signal between connection objects. Examples of “a material having some electrical action” include electrodes, wiring, switching elements, and other elements having various functions.

An active circuit may be disposed at a middle portion between microstrip lines of the transmission line 2, for example. That is, an active circuit may be electrically connected between lines of the transmission line 2. The active circuit may be a terahertz wave integrated circuit, a resonant tunneling diode (RTD), an MOS element, an active filter circuit, or the like, for example.

### (Circuit Configuration of Transmission Line)

FIG. 3A illustrates the distributed constant circuit 10 according to the first embodiment and is an equivalent circuit diagram of one period. FIG. 3B illustrates the distributed constant circuit 10 according to the first embodiment and is an equivalent circuit diagram of two periods.

The distributed constant circuit 10 is represented by a one-dimensional LC ladder circuit with a stepped-impedance circuit configuration of FIGS. 1A and 1B.

As illustrated in FIG. 3A, as a configuration for one period, the periodic structure 100 of the transmission line 2 can be represented as a configuration in which the first series inductor La, the parallel capacitor C, the second series inductor Lb, the parallel capacitor C, and the first series inductor La are electrically connected in this order.

As illustrated in FIG. 3A, an equivalent circuit of the periodic structure 100 of the transmission line 2 includes the first series inductors La, the second series inductor Lb connected in series with the first series inductors La, and the parallel capacitors C electrically connected between the ground electrode 3, and connection points between the first series inductors La and the second series inductor Lb. That is, the first lines 21₁ and 21₂ include the first series inductors La, the second lines 22₁ and 22₂ include the parallel capacitors C, and the third line 23₁ includes the second series inductor Lb.

As illustrated in FIG. 3B, as a configuration for two periods, each of the periodic structures 100, 200 of the transmission line 2 can be represented as a configuration in which the first series inductor La, the parallel capacitor C, the second series inductor Lb, the parallel capacitor C, and the first series inductor La are electrically connected in this order.

As illustrated in FIG. 3B, an equivalent circuit of the periodic structures 100, 200 of the transmission line 2 includes the first series inductors La, the second series inductor Lb connected in series with the first series inductors La, and the parallel capacitors C electrically connected between the ground electrode 3, and connection points between the first series inductors La and the second series inductor Lb. That is, each of the first lines 21₁ and 21₂ includes the first series inductor La, each of the second lines 22₁ and 22₂ includes the parallel capacitor C, and the third line 23₁ includes the second series inductor Lb.

The second series inductor Lb has an inductance with a value higher than that of the first series inductor La (Lb>La).

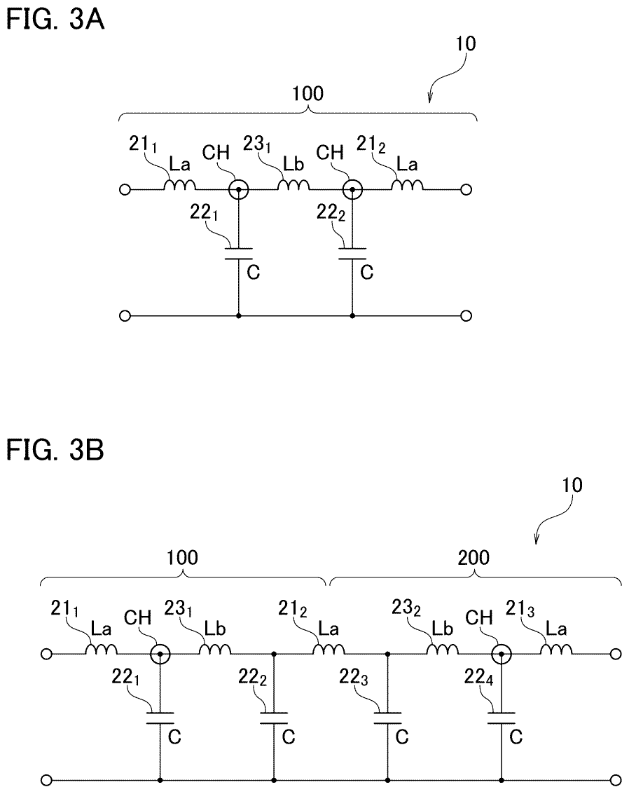

The equivalent circuit of the periodic structures 100, 200 has topological characteristics. The topological characteristics refer to characteristic in which due to a unique topological phase of a wave function of an electron or electromagnetic wave, a current or electromagnetic wave is not able to pass in a sample, but quantized channels CH appear at ends, and this enables transmission of a strong current or electromagnetic wave. That is, the equivalent circuit of the periodic structures 100, 200 has characteristics in which due to a unique topological phase of a wave function of an electron or electromagnetic wave, the channels CH at a specific frequency appear at ends of a circuit (in this case, positions between the first series inductor La and the second series inductor Lb). The topological characteristics will be described below with reference to FIGS. 4A to 6.

The equivalent circuit of the periodic structures 100, 200 arranges structures having topological characteristics in a one-dimensional manner. That is, as illustrated in FIGS. 1A and 1B, the periodic structures 100, 200 are structures having topological characteristics which are arranged periodically in the X direction in a one-dimensional manner. The periodic structures 100, 200 may be periodically arranged in the Y direction in a one-dimensional manner.

As described above, in the distributed constant circuit 10 according to the first embodiment, due to a periodic structure having topological characteristics, the channels CH at a specific frequency appear at the ends (in this case, positions between the first series inductor La and the second series inductor Lb) of the periodic structure.

In addition, due to the distributed constant circuit 10 according to the first embodiment including the transmission line 2 arranged on the first main surface 1a of the dielectric 1, it is possible to simplify a process step.

Further, the distributed constant circuit 10 according to the first embodiment can be reduced in size and height by constituting a passive element of the circuit by the width of the transmission line 2 formed in the circuit.

### (Topological Characteristics)

The topological characteristics will be briefly described.

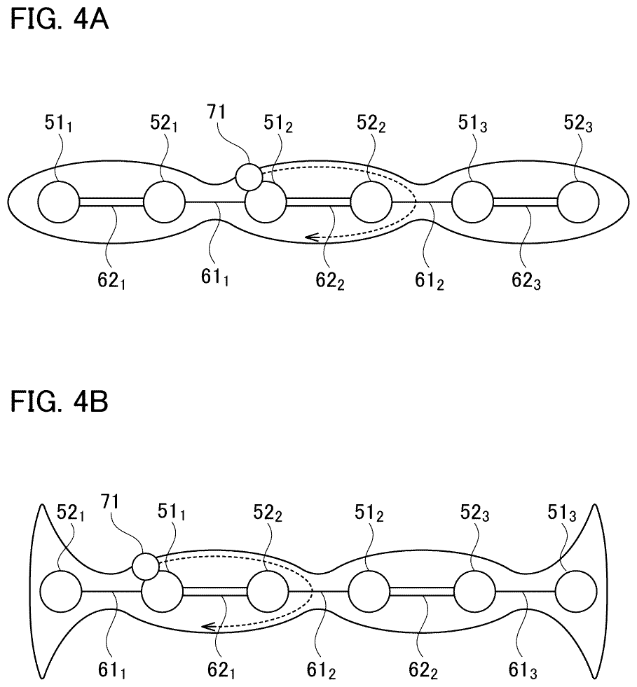

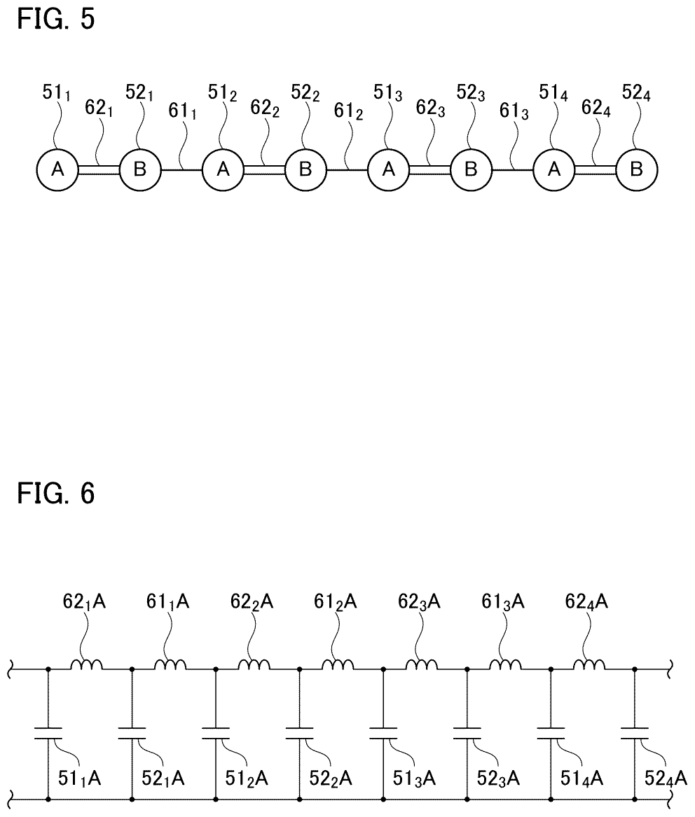

FIG. 4A is an explanatory diagram of a Su-Schrieffer-Heeger model (hereinafter referred to as SSH model) without topological characteristics. FIG. 4B is an explanatory diagram of the SSH model with topological characteristics. FIG. 5 is an explanatory diagram illustrating polyacetylene with carbon atoms 511 to 514 and 521 to 524, single bonds 611, 612, and 613, and double bonds 621 to 624. FIG. 6 is an equivalent circuit diagram simulating the carbon atoms 511 to 514 and 521 to 524, single bonds 611, 612, and 613, and double bonds 621 to 624.

Regarding the topological characteristics, taking polyacetylene as an example, polyacetylene is represented as in FIGS. 4A and 4B, for example. As illustrated in FIGS. 4A and 4B, polyacetylene can be represented as carbon atoms 511, 512, 513, 521, 522, and 523, single bonds 611, 612, and 613, double bonds 621, 622, and 623, and an electron 71.

For polyacetylene, the single bonds 611, 612, and 613 and double bonds 621, 622, and 623 are alternately formed between the carbon atoms 511 to 514 and 521 to 524 to form a one-dimensional chain, for example. The difference between FIG. 4A and FIG. 4B resides in the sequence of transition probabilities for the electron 71 to transit to an adjacent carbon atom. As illustrated in FIG. 4A, an electronic state, when a transition probability between the carbon atoms 511 and 521 including the carbon atom 511 at an end increase, does not have topological characteristics. That is, it exhibits characteristics of an insulator.

Meanwhile, as illustrated in FIG. 4B, when the transition probability between the carbon atoms 511 and 521 including the carbon atom 521 at an end is small, a state is caused in which excess electrons at an end are localized at the end. That is, FIG. 4B illustrates the wave function spread of the excess electrons at the carbon atom 521 at the end. In other words, in the end state with the wave function spread of the excess electrons, characteristics are caused in which due to unique topological phases of wave functions of electrons, quantized channels CH appear at ends, and this enables transmission of electrons. In other words, when the transition probability between the carbon atoms 511 and 521 including the carbon atom 521 at the end is small, the state has topological characteristics.

As described above, in order to explain the topological characteristics by taking polyacetylene as an example, a model in which atoms are arranged in a one-dimensional or two-dimensional lattice manner will be referred to as an SSH model.

In addition, as illustrated in FIG. 6, the topological characteristics of the SSH model can be obtained even if the carbon atoms 511 to 514, 521 to 524, single bonds 611, 612, 613, and double bonds 621, 622, 623, 624 are simulated to the equivalent circuit having the second series inductors 611A, 612A, 613A, first series inductors 621A, 622A, 623A, 624A, and parallel capacitors 511A, 512A, 513A, 514A, 521A, 522A, 523A, 524A, for example.

That is, the carbon atoms 511, 512, 513, 514, 521, 522, 523, 524 can be represented as the parallel capacitors 511A, 512A, 513A, 514A, 521A, 522A, 523A, 524A, as illustrated in FIG. 6. Further, the single bonds 61 can be represented as the second series inductors 611A, 612A 613A, as illustrated in FIG. 6. Similarly, the double bonds 621, 622, 623, 624 can also be represented as the first series inductors 621A, 622A, 623A, 624A, as illustrated in FIG. 6. The carbon atoms 521, 522, 523, 524 may be the carbon atoms 511, 512, 513, 514. That is, the parallel capacitors 521A, 522A, 523A, 524A may be the parallel capacitors 511A, 512A, 513A, 514A.

In order for the equivalent circuit of FIG. 6 to have the topological characteristics, the equivalent circuit having the configuration of FIG. 4B is required. That is, for the equivalent circuit of FIG. 6, an equivalent circuit is required in which the second series inductor 611A, parallel capacitor 512A, first series inductor 622A, parallel capacitor 522A, and second series inductor 612A are arranged in this order. That is, the equivalent circuit of the periodic structure 100 illustrated in FIG. 3A and the periodic structures 100, 200 illustrated in FIG. 3B has the topological characteristics.

### Second Embodiment

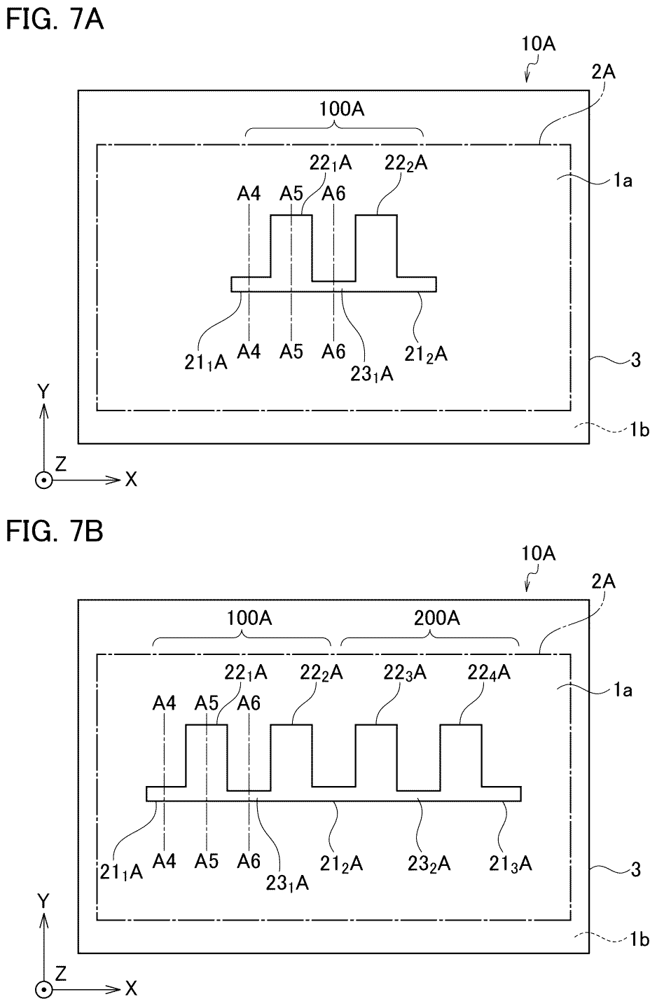

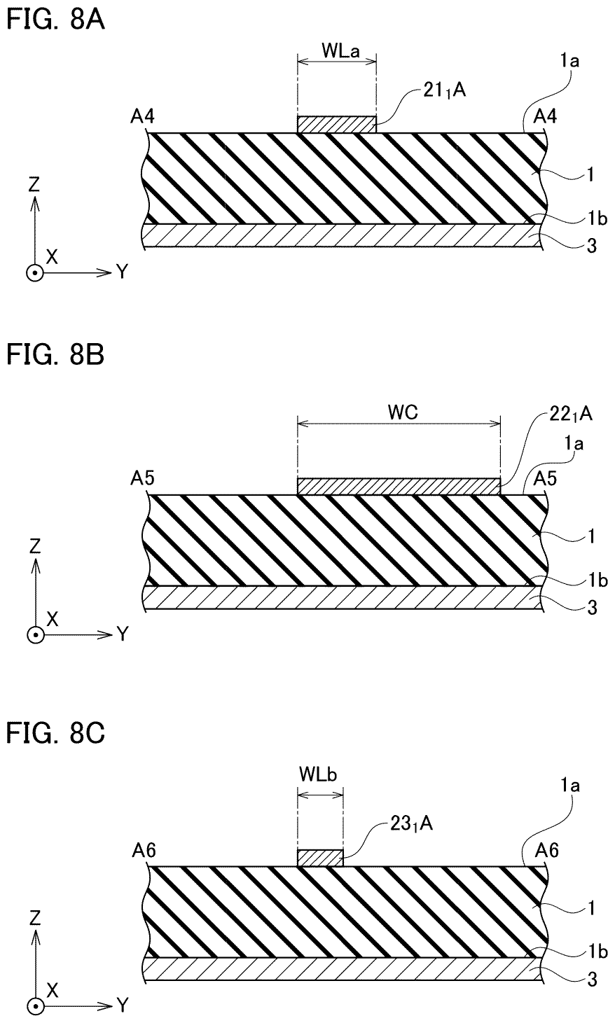

A distributed constant circuit 10A according to a second embodiment will be described with reference to the drawings. FIG. 7A illustrates the distributed constant circuit 10A according to the second embodiment and is a configuration diagram for one period. FIG. 7B illustrates a distributed constant circuit 10A according to the second embodiment and is a configuration diagram for two periods. FIG. 8A is a cross-sectional view which is taken along line A4-A4 in FIGS. 7A and 7B. FIG. 8B is a cross-sectional view which is taken along line A5-A5 in FIGS. 7A and 7B. FIG. 8C is a cross-sectional view which is taken along line A6-A6 in FIGS. 7A and 7B.

The difference between the first embodiment and the second embodiment resides in that, while the second lines 22₁, 22₂, 22₃, 22₄ of the transmission line 2 in the first embodiment are stepped-impedance types, second lines 221A, 222A, 223A, 224A of the second embodiment are open-stub types. Other configurations of the second embodiment are the same as those of the first embodiment.

As illustrated in FIGS. 7A, 7B, and 8A to 8C, a transmission line 2A is disposed on a first main surface 1a. As illustrated in FIG. 7A, the transmission line 2A has first lines 211A, 212A, second lines 221A, 222A, and a third line 231A which are formed to have different widths. Further, as illustrated in FIG. 7B, the transmission line 2A has first lines 211A, 212A, 213A, second lines 221A, 222A, 223A, 224A, and third lines 231A, 232A which are formed to have different widths. The first lines 211A, 212A, 213A, the second lines 221A, 222A, 223A, 224A, and the third lines 231A, 232A are formed of metals having good conductivity. Specifically, copper (Cu), aluminum (A1), and gold (Au) can be used.

The transmission line 2A includes a microstrip line. That is, the transmission line 2A can be formed by a transmission path of a microstrip line, for example. The transmission line 2A is not limited to a microstrip line. In the following description, the transmission line 2A will be described using a microstrip line as an example.

As illustrated in FIG. 7A, the transmission line 2A includes, as a configuration for one period, a periodic structure 100A in which the first line 211A, the second line 221A, the third line 231A, the second line 222A, and the first line 212A are arranged in series in this order. Further, as illustrated in FIG. 7A, in the transmission line 2A, the first line 211A, the second line 221A, the third line 231A, the second line 222A, and the first line 212A are electrically connected. In the following description, a structure in which the first line 211A, the second line 221A, the third line 231A, the second line 222A, and the first line 212A are arranged in series in this order will be referred to as the periodic structure 100A. Note that the number of the periodic structure 100A is not limited to one.

As illustrated in FIG. 7B, the transmission line 2A includes, as a configuration for two periods, the periodic structure 100A in which the first line 211A, the second line 221A, the third line 231A, the second line 222A, and the first line 212A are arranged in this order, and a periodic structure 200A in which the first line 212A, the second line 223A, the third line 232A, the second line 224A, and the first line 213A are arranged in this order. Further, as illustrated in FIG. 7B, in the transmission line 2A, the first line 212A, the second line 223A, the third line 232A, the second line 224A, and the first line 213A are electrically connected. In the following description, a structure in which the first line 212A, the second line 223A, the third line 232A, the second line 224A, and the first line 213A are arranged in series in this order will be referred to as the periodic structure 200A. The number of the periodic structures 100A, 200A may be more than one and they may be electrically connected.

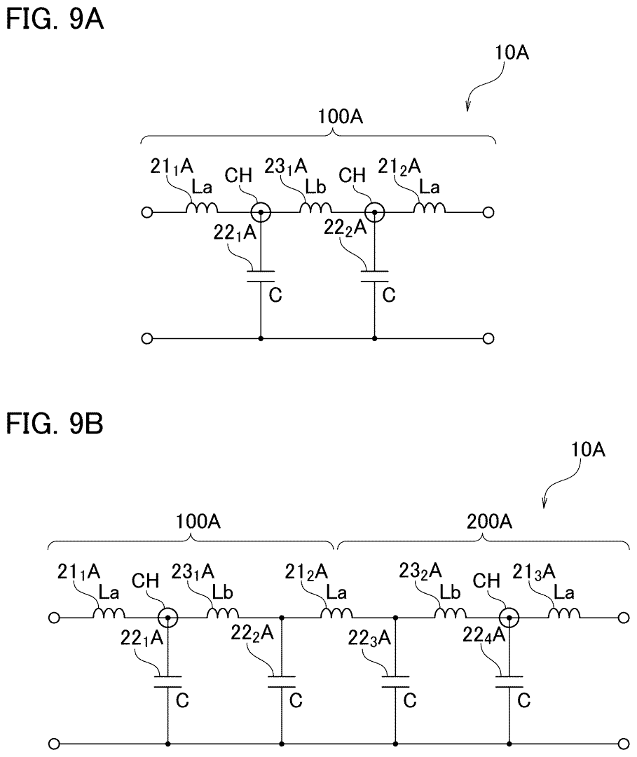

A circuit configuration of the transmission line 2A will be described below with reference to FIGS. 9A and 9B.

As illustrated in FIGS. 7A, 7B, and 8A, the first line 211A is formed to have a small line width WLa in the Y direction as a microstrip line of the transmission line 2A, and functions as a first series inductor La. As illustrated in FIG. 8A, the first line 211A is disposed on the first main surface 1a opposed to a second main surface 1b on which a ground electrode 3 is disposed, with a dielectric 1 being interposed between the first main surface 1a and the second main surface 1b.

As illustrated in FIGS. 7A, 7B, and 8B, the second line 221A is formed to have a large line width WC in the Y direction as a microstrip line of the transmission line 2A, and functions as a parallel capacitor C. As illustrated in FIG. 8B, the second line 221A is arranged on the first main surface 1a. As illustrated in FIGS. 7A and 7B, the line width WC of the second line 221A is larger than the line width WLa of the first line 211A and a line width WLb of the third line 231A.

As illustrated in FIGS. 7A, 7B, and 8C, the third line 231A is formed to have a small line width WLb in the Y direction as a microstrip line of the transmission line 2A, and functions as a second series inductor Lb. As illustrated in FIG. 8C, the third line 231A is arranged on the first main surface 1a. As illustrated in FIGS. 7A and 7B, the line width WLb of the third line 231A is smaller than the line width WLa of the first line 21₁.

### (Circuit Configuration of Transmission Line)

FIG. 9A illustrates the distributed constant circuit 10A according to the second embodiment and is an equivalent circuit diagram of one period. FIG. 9B illustrates the distributed constant circuit 10A according to the second embodiment and is an equivalent circuit diagram of two periods.

The distributed constant circuit 10A is represented by a one-dimensional LC ladder circuit with an open-stub circuit configuration of FIGS. 7A and 7B.

As illustrated in FIG. 9A, as a configuration for one period, the periodic structure 100A of the transmission line 2A can be represented as a configuration in which the first series inductor La, the parallel capacitor C, the second series inductor Lb, the parallel capacitor C, and the first series inductor La are electrically connected in this order.

As illustrated in FIG. 9A, an equivalent circuit of the periodic structure 100A of the transmission line 2A includes the first series inductors La, the second series inductor Lb connected in series with the first series inductors La, and the parallel capacitors C electrically connected between the ground electrode 3, and connection points between the first series inductors La and the second series inductor Lb. That is, each of the first lines 211A, 212A includes the first series inductor La, each of the second lines 221A, 222A includes the parallel capacitor C, and the third line 231A includes the second series inductor Lb.

As illustrated in FIG. 9B, as a configuration for two periods, each of the periodic structures 100A, 200A of the transmission line 2A can be represented as a configuration in which the first series inductor La, the parallel capacitor C, the second series inductor Lb, the parallel capacitor C, and the first series inductor La are electrically connected in this order.

As illustrated in FIG. 9B, an equivalent circuit of the periodic structures 100A, 200A of the transmission line 2A includes the first series inductors La, the second series inductors Lb connected in series with the first series inductors La, and the parallel capacitors C electrically connected between the ground electrode 3, and connection points between the first series inductors La and the second series C inductors Lb. That is, each of the first lines 211A, 212A, 213A includes the first series inductor La, each of the second lines 221A, 222A, 223A, 224A includes the parallel capacitor C, and each of the third lines 231A, 232A includes the second series inductor Lb.

Each second series inductor Lb has an inductance with a value higher than that of each first series inductor La (Lb>La).

The equivalent circuit of the periodic structures 100A and 200A has topological characteristics.

The equivalent circuit of the periodic structures 100A, 200A arranges structures having topological characteristics in a one-dimensional manner. That is, as illustrated in FIGS. 7A and 7B, the periodic structures 100A, 200A are structures having topological characteristic which are arranged periodically in the X direction in a one-dimensional manner. The periodic structures 100A, 200A may be periodically arranged in the Y direction in a one-dimensional manner.

As described above, in the distributed constant circuit 10A according to the second embodiment, due to a periodic structure having topological characteristics, channels CH at a specific frequency appear at ends (in this case, positions between the first series inductor La and the second series inductor Lb) of the periodic structure.

Further, due to the distributed constant circuit 10A according to the second embodiment including the transmission line 2A arranged on the first main surface 1a of the dielectric 1, it is possible to simplify a process step.

Further, the distributed constant circuit 10A according to the second embodiment can be reduced in size and height by constituting a passive element of the circuit by the width of the transmission line 2A formed in the circuit.

### Third Embodiment

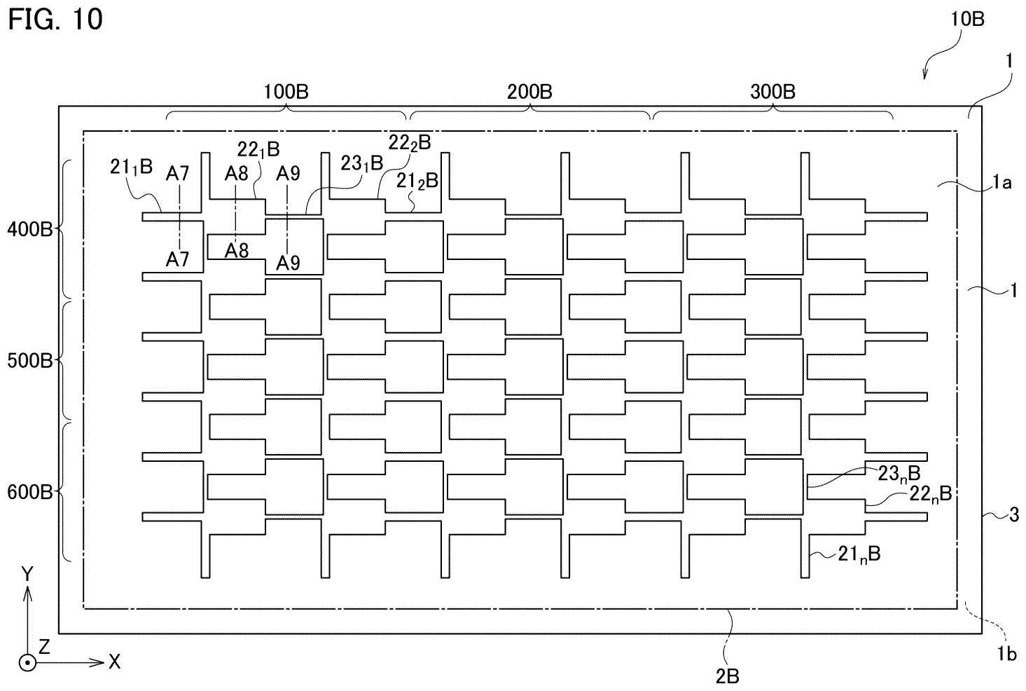

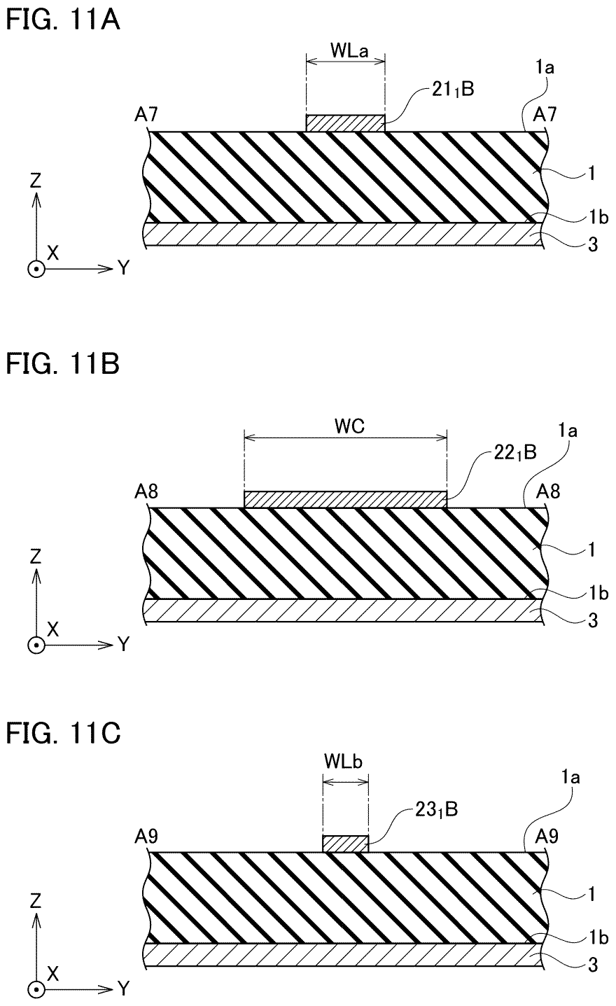

A distributed constant circuit 10B according to a third embodiment will be described with reference to the drawings. FIG. 10 illustrates the distributed constant circuit 10B according to the third embodiment and is a configuration diagram for three periods in the X and Y directions. FIG. 11A is a cross-sectional view which is taken along line A7-A7 in FIG. 10. FIG. 11B is a cross-sectional view which is taken along line A8-A8 in FIG. 10. FIG. 11C is a cross-sectional view which is taken along line A9-A9 in FIG. 10.

The difference between the first embodiment and the third embodiment resides in that, in the first embodiment, the periodic structure 100 is arranged in a one-dimensional manner in the X direction, while in the third embodiment, periodic structures 100B, 200B, 300B, 400B, 500B, 600B are arranged in a two-dimensional manner in the X and Y directions. Other configurations of the third embodiment are the same as those of the first embodiment.

As illustrated in FIG. 10, a transmission line 2B is disposed on a first main surface 1a. As illustrated in FIG. 10, the transmission line 2B has first lines 21₁B to 21ₙB, second lines 22₁B to 22ₙB, and third line 23₁B to 23ₙB which are formed to have different widths. The first lines 21₁B to 21ₙB, the second lines 22₁B to 22ₙB, and the third line 23₁B to 23ₙB are formed of metals having good conductivity. Specifically, copper (Cu), aluminum (A1), and gold (Au) can be used.

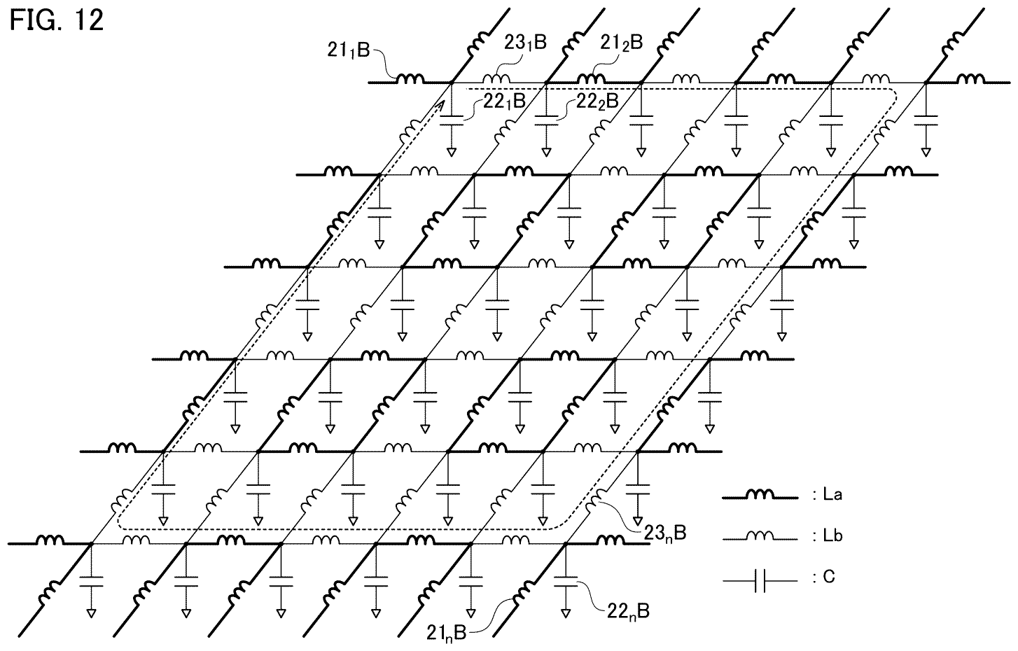

As illustrated in FIG. 10, the transmission line 2B includes the periodic structure 100B in which the first line 21₁B, the second line 22₁B, the third line 23₁B, the second line 22₂B, and the first line 21₂B are arranged in series in this order. Further, as illustrated in FIG. 10, in the transmission line 2B, the first line 21₁B, the second line 22₁B, the third line 23₁B, the second line 22₂B, and the first line 21₂B are electrically connected. In the following description, a structure in which the first line 21₁B, the second line 22₁B, the third line 23₁B, the second line 22₂B, and the first line 21₂B are arranged in series in this order will be referred to as the periodic structure 100B. In FIGS. 10 and 12, reference numerals of a first line, a second line, a third line, a second line, and a first line of each of the periodic structures 200B, 300B, 400B, 500B, 600B are omitted. Still further, in the following description, a first line, a second line, a third line, a second line, and a first line of each of the periodic structures 200B, 300B, 400B, 500B, 600B will be referred to as a first line 21B, a second line 22B, a third line 23B, a second line 22B, and a first line 21B.

The transmission line 2B includes the periodic structures 200B, 300B in each of which the first line 21B, the second line 22B, the third line 23B, the second line 22B, and the first line 21B are arranged in series in this order in the X direction, similar to the periodic structure 100B. Further, the transmission line 2B includes the periodic structures 400B, 500B, 600B in each of which the first line 21B, the second line 22B, the third line 23B, the second line 22B, and the first line 21B are arranged in series in this order in the Y direction. In each of the periodic structures 200B, 300B, 400B, 500B, 600B of the transmission line 2B, the first line 21B, the second line 22B, the third line 23B, the second line 22B, and the first line 21B are electrically connected. The number of the periodic structure 100B is not limited to one. The number of the periodic structures 100B, 200B, 300B, 400B, 500B, 600B may be more than one and they may be electrically connected.

A circuit configuration of the transmission line 2B will be described below with reference to FIG. 12.

As illustrated in FIGS. 10 and 11A, the first line 21₁B is formed to have a small line width WLa in the Y direction as a microstrip line of the transmission line 2B, and functions as a first series inductor La. As illustrated in FIGS. 10 and 11A, the first lines 21₁B to 21ₙB are arranged on the first main surface 1a.

As illustrated in FIGS. 10 and 11B, the second line 22₁B is formed to have a large line width WC in the Y direction as a microstrip line of the transmission line 2B, and functions as a parallel capacitor C. As illustrated in FIG. 11B, the second lines 22₁B to 22ₙB are arranged on the first main surface 1a. As illustrated in FIG. 10, the line width WC of the second lines 22₁B to 22ₙB are larger than the line width WLa of the first lines 21₁B to 21ₙB and a line width WLb of the third lines 23₁B to 23ₙB.

As illustrated in FIGS. 10 and 11C, the third line 23₁B is formed to have the small the line width WLb in the X direction as a microstrip line of the transmission line 2B, and functions as a second series inductor Lb. As illustrated in FIG. 11C, the third line 23₁B is arranged on the first main surface 1a. As illustrated in FIG. 10, the line width WLb of the third line 23₁B is smaller than the line width WLa of the first line 21₁B.

### (Circuit Configuration of Transmission Line)

FIG. 12 illustrates the distributed constant circuit 10B according to the third embodiment and is an equivalent circuit diagram illustrating a configuration for three periods in the X and Y directions.

The distributed constant circuit 10B of the equivalent circuit is represented by a two-dimensional LC ladder circuit with a stepped-impedance type of FIG. 10.

As illustrated in FIG. 12, each of the periodic structures 100B, 200B, 300B, 400B, 500B, 600B of the transmission line 2B can be represented as a configuration in which the first series inductor La, the parallel capacitor C, and the second series inductor Lb are electrically connected in this order.

As illustrated in FIG. 12, the equivalent circuit of the periodic structures 100B, 200B, 300B, 400B, 500B, 600B of the transmission line 2B includes the first series inductors La, the second series inductors Lb connected in series with the first series inductors La, and the parallel capacitors C electrically connected between a ground electrode 3, and connection points between the first series inductors La and the second series inductors Lb. That is, each of the first lines 21₁B to 21ₙB includes the first series inductor La, each of the second lines 22₁B to 22ₙB includes the parallel capacitor C, and each of the third lines 23₁B to 23ₙB includes the second series inductor Lb.

Each second series inductor Lb has an inductance with a value higher than that of each first series inductor La (Lb>La).

The equivalent circuit of the periodic structures 100B, 200B, 300B, 400B, 500B, 600B has topological characteristics. Each peripheral portion of the circuit constituted by the periodic structures 100B, 200B, 300B, 400B, 500B, 600B functions as a band-pass filter circuit.

The equivalent circuit of the periodic structures 100B, 200B, 300B, 400B, 500B, 600B arranges structures having topological characteristics in a two-dimensional manner. That is, as illustrated in FIG. 12, the periodic structures 100B, 200B, 300B, 400B, 500B, 600B are periodically arranged in a two-dimensional manner in both of the X and Y directions.

As described above, in the distributed constant circuit 10B according to the third embodiment, due to the periodic structures having topological characteristics, currents can be conducted at a specific frequency to peripheral portions of the periodic structures (in this case, connection points between the first series inductors La and the second series inductors Lb at edges of the circuit).

Further, due to the distributed constant circuit 10B according to the third embodiment including the transmission line 2B arranged on the first main surface 1a of a dielectric 1, it is possible to simplify a process step.

Further, the distributed constant circuit 10B according to the third embodiment can be reduced in size and height by constituting a passive element of the circuit by the width of the transmission line 2B formed in the circuit.

### Other Embodiments

Although several embodiments have been described above, the discussion and drawings forming part of this disclosure are illustrative and should not be construed as limiting the invention. Various alternative embodiments, examples, and operational techniques will be apparent to those skilled in the art from this disclosure. In this way, the embodiments herein include various embodiments and the like not described herein.

1. A distributed constant circuit, comprising:
a dielectric including a first main surface and a second main surface opposed to the first main surface;
a transmission line arranged on the first main surface; and
a ground electrode arranged on the second main surface, wherein
the transmission line includes a first line, a second line, and a third line that are formed to have different widths, and
the transmission line includes a periodic structure in which the first line, the second line, the third line, the second line, and the first line are arranged in series in this order.

2. The distributed constant circuit according to claim 1, wherein
the periodic structure is a periodic structure or a plurality of periodic structures that are electrically connected.

3. The distributed constant circuit according to claim 1, wherein
the periodic structure has a topological characteristic.

4. The distributed constant circuit according to claim 1, wherein
a width of the third line is smaller than a width of the first line.

5. The distributed constant circuit according to claim 1, wherein
a width of the second line is larger than a width of the first line and a width of the third line.

6. The distributed constant circuit according to claim 1, wherein
the first line includes a first series inductor.

7. The distributed constant circuit according to claim 6, wherein
the second line includes a parallel capacitor.

8. The distributed constant circuit according to claim 7, wherein
the third line includes a second series inductor.

9. The distributed constant circuit according to claim 8, wherein
the periodic structure includes:
the first series inductor;
the second series inductor connected in series with the first series inductor; and
the parallel capacitor electrically connected between the ground electrode and a connection point between the first series inductor and the second series inductor.

10. The distributed constant circuit according to claim 8, wherein
the second series inductor has an inductance with a value higher than a value of an inductance of the first series inductor.

11. The distributed constant circuit according to claim 1, wherein
the periodic structure is periodically arranged in a first direction in a one-dimensional manner.

12. The distributed constant circuit according to claim 1, wherein
the periodic structure is periodically arranged in a second direction in a one-dimensional manner.

13. The distributed constant circuit according to claim 1, wherein
the periodic structure is periodically arranged in both a first direction and a second direction in a two-dimensional manner.

14. The distributed constant circuit according to claim 1, wherein
the transmission line includes a microstrip line.
